(19) United States
(12) Patent Application Publication
(10) Pub. No.: US 2007/0100881 A1
(43) Pub. Date: May 3, 2007

(54) METHOD, SYSTEM AND STORAGE MEDIUM FOR IDENTIFYING AND ALLOCATING SURPLUS INVENTORY

(75) Inventors: Stephen T. McDonald, Staatsburg, NY (US); Anthony V. Ferreri, Hyde Park, NY (US); Richard J. Lukes, Denver, NC (US); Michael T. Phelan, Milton, NY (US)

Correspondence Address: LAW OFFICE OF DELIO & PETERSON, LLC., 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/163,583

(22) Filed: Oct. 24, 2005

(51) Int. Cl. G06F 17/00

(52) U.S. Cl. 707/104.1

(57) ABSTRACT

Methods, systems and apparatus for exhausting surplus inventory within currently existing supplies. Intra-enterprise and inter-enterprise lists of surplus inventories are input into a planning engine along with allocation rules for establishing priorities and preferences of allocating and exhausting parts within existing inventories. The planning engine also receives central parameter file inputs for identifying those parts within surplus inventory that can be allocated to other enterprises. Using an identifier of a requested part, the planning engine then analyzes the lists of surplus inventories for compatible parts, and builds hierarchy allocation plans using selected inputs dependent upon which list the compatible parts are located. These hierarchy allocation plans are output in tables for allowing a user to select a plan that exhausts surplus inventory prior to such inventory being declared as excess. Reports are also output for providing demand forecasts of the surplus inventory based on the output hierarchy allocation plans.

### BACKGROUND OF THE INVENTION

1. Field of the Invention

The present invention is directed generally to exhausting existing inventory, and in particular, to methods, systems and apparatus for identifying available surplus inventory within existing supplies and exhausting such inventory prior to it being declared as an overage or excess inventory.

2. Description of Related Art

In today's business environment, the manufacture of large, mid-range, and client computer (e.g., desktop or mobile) products and technologies are continually and rapidly evolving. However, with these new technologies comes an increase in the rate of engineering changes in design developments. It is these engineering changes that cause high turnover rates in computer parts and products, which in turn, undesirably lead to an abundance of excess inventory within existing supplies. Since excess inventory typically becomes obsolete fairly quickly due to newer technologies requiring updated parts and products, suppliers are often burdened with this remaining excess inventory, which can lead to substantial losses both in manufacturing time and money.

Conventional approaches aimed at solving the problems associated with excess inventory address such problems after supplies have been designated as being excess inventory. For example, wherein a supplier determines that he has a certain quantity of items in-stock, and these items are no longer useable with current technology requirements, these items are identified and designated as excess inventory. Once inventory has been designated as excess, it is at this point that the supplier must then determine how to exhaust such inventory.

Scrapping and/or reworking excess inventory are typical ways of exhausting or reducing the amount of such inventory. However, these approaches are disadvantageous since the supplier often spends a significant amount of time and money accomplishing the tasks of scrapping and/or reworking excess inventory. Additionally, scrapping of excess inventory wastes product parts and supplies thereby leading to an even further loss realized by the supplier.

Alternative attempts have been made at reducing the amount of excess inventory by finding non-designated uses for such inventory within the supplier's company. Yet, this approach also requires significant expenditures on the part of the supplier in finding these non-designated uses, as well as leads to an increase in manufacturing time.

Accordingly, a need exists in the art for improved methods, systems and apparatus for exhausting surplus inventory while reducing both manufacturing time and costs.

### SUMMARY OF THE INVENTION

Bearing in mind the problems and deficiencies of the prior art, it is therefore an object of the present invention to provide methods, systems and apparatus for identifying available surplus inventory within existing supplies and exhausting such surplus inventory prior to it being designated as an overage or excess inventory.

Another object of the present invention is to provide methods, systems and apparatus for exhausting surplus inventory by allocating the inventory to non-designated operations that are able to utilize such surplus inventory prior to it being designated as an overage or excess inventory.

It is another object of the present invention to provide methods, systems and apparatus for consuming surplus inventory that significantly reduce manufacturing and supplier costs and time.

A further object of the invention is to provide methods, systems and apparatus that share identified surplus inventory with both inter-enterprise entities and intra-enterprise entities.

Still another object of the invention is to provide methods, systems and apparatus for automatically identifying and allocating surplus inventory to significantly eliminate validation errors and reduce exhaustive analysis time.

It is yet another object of the present invention to provide methods, systems and apparatus that support use of parts “as is” and/or “use up” as a result of engineering changes.

Yet another object of the present invention is to provide methods, systems and apparatus that support discontinuation and consumption of any type of surplus inventory.

Other objects and advantages of the invention will in part be obvious and will in part be apparent from the specification.

The above and other objects, which will be apparent to those skilled in art, are achieved in the present invention, which is directed to in a first aspect a method for exhausting surplus inventory. The method includes identifying existing surplus inventory and then inputting into a planning engine lists of the surplus inventory, allocation rules, and an identifier of a requested part. Using the identifier of the requested part, the planning engine analyzes the lists of surplus inventory for locating compatible parts, whereby hierarchy allocation plans are then built using the allocation rules and the located compatible parts. The hierarchy allocation plans are then output from the planning engine for allowing a user to select at least one of the hierarchy allocation plans for exhausting existing surplus inventory. In accordance with the invention, the planning engine preferably includes a materials requirement planning component for generating the hierarchy allocation plans.

In this aspect, the input lists of the surplus inventory may include input intra-enterprise lists and input inter-enterprise lists of available surplus inventories. Allocation rules are associated with both the intra-enterprise list and the inter-enterprise lists of available surplus inventory. The inter-enterprise lists establish relationships between various enterprises by identifying selected enterprises that are willing to allocate and share compatible parts with other enterprises utilizing the present invention. A central parameters file is also input into the planning engine for automatically identifying those parts in inter-enterprise lists of surplus inventory that can be allocated amongst other enterprises.

In the step of locating compatible parts, the intra-enterprise list of available surplus inventory may be analyzed for compatible parts, and if located, the hierarchy allocation plans are generated using the intra-enterprise allocation rules and the compatible parts located within the enterprise for exhausting existing surplus inventory within the enterprise. Alternatively, the inter-enterprise list of available surplus inventory may be analyzed for compatible parts, particularly if no compatible parts or not enough compatible parts were located in the intra-enterprise list of surplus inventory. If compatible parts are located in the inter-enterprise lists, and it is determined that these compatible parts are identical to the requested part, then the hierarchy allocation plans are generated using the inter-enterprise lists, the central parameters file, and the identical compatible parts. If, however, the compatible parts are not identical to the requested parts, then the hierarchy allocation plans are built using the intra-enterprise and inter-enterprise lists of surplus inventory, the central parameters file, and the non-identical compatible parts for exhausting existing surplus inventory with the various enterprises.

In accordance with the invention, the inter-enterprise allocation rules include information on enterprise preferences for compatible parts, enterprise priorities for sending compatible parts, enterprise priorities for receiving compatible parts, expenditure allowances, and combinations thereof. The central parameters file includes substitution rules for determining a time line for declaring and identifying stocked inventory as surplus inventory, a time horizon of availability of such surplus inventory, and a quantity of the surplus inventory that is currently available in each enterprise.

Using the central parameters file, the method may further include determining if open orders exist for the compatible parts located within the inter-enterprise lists, and if so, generating the hierarchy allocation plans based on such open orders. The central parameters file may also determine whether the located compatible parts are classified as end-of-life parts, and if so, identify those end-of-life enterprises that are willing to allocate and share such end-of-life parts with each other. In this aspect, the hierarchy allocation plans are built bearing in mind the existence of end-of-life parts and the identity of the enterprises willing to share such end-of-life parts. Further, the planning engine outputs the hierarchy allocation plans in output tables, as well as outputs reports for providing future demand forecasts of the existing surplus inventory based on the output hierarchy allocation plans. It is preferred that the hierarchy allocation plans be output to the user prior to the lists of surplus inventory being declared as excess inventory.

It should be appreciated and understood that the compatible parts may be identical parts, equivalent parts, non-identical substitute parts, up-level parts, equal-level parts, down-level parts, or even combinations thereof. The user may be an enterprise, a plant, a factory, a manufacturer, a supplier, a distributor or a storage facility, while the identifier of the requested part may be a part number, a catalog number, a catalog name, a part name or a subpart name.

The invention also includes systems and program storage devices capable of carrying out the method steps described herein.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 illustrates the present system architecture with its process flow in accordance with the invention.

### DESCRIPTION OF THE PREFERRED EMBODIMENTS

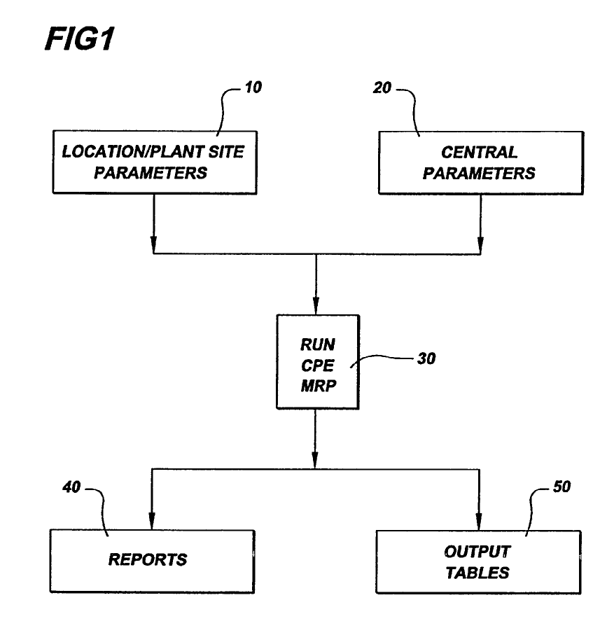

In describing the preferred embodiment of the present invention, reference will be made herein to FIG. 1 of the drawings in which like numerals refer to like features of the invention.

Conventional Materials Requirement Planning (MRP) systems are designed to handle inventory overages after the inventory has been identified and declared as excess inventory. Further, these systems are set up to deal with the problems of excess inventory within the four walls of a given entity. It is these problems, in addition to the problems discussed above, that cause conventional MRP systems to lead to a significant loss both in manufacturing time and costs, as well as limit the sharing capabilities of existing inventory, amongst other problems.

The present invention solves the problems associated with conventional MRP systems by utilizing and exhausting existing inventories, and parts within inventories, before they can be declared as overage, excess, or scrap. The invention also provides the capability to share and utilize currently existing parts across Intra-Company Interplant Locations and Inter-Company parts for those users participating within the present MRP Supply Chain System.

For ease of understanding the invention, FIG. 1 shows a preferred system architecture with its process flow in accordance with the invention. As used herein, the term enterprise refers to an entity that manufactures, stores and/or distributes inventory including, but not limited to, a plant, factory, manufacturer, supplier or distributor and the like.

Referring to FIG. 1, the Location and Plant Site Parameters file 10 includes a Substitute Parts file and an Interplant Relationship file. This Location and Plant Site Parameters file 10 is generated by a user of the system inputting surplus inventory information into a Substitute Parts table and an Interplant Relationship table, which are then both converted into files. A user of the invention may include an enterprise, an employee of the enterprise, an orderer affiliated with the enterprise, a supplier affiliated with the enterprise, and the like. That is, a user designates inventory within the enterprise as being in surplus within the enterprise's currently existing stock for use by either the enterprise itself or allocation to other enterprises; however, such inventory is not declared as an overage or excess. This is necessary, in order to insure the cost avoidance associated with the cost of unused parts in inventory and storage, resulting in the unused parts ultimately either being scraped or sold at a lesser value. Additionally, excess inventory always has a direct impact on the quarterly earnings statement and profit for a company.

The Substitute Parts file identifies and lists intra-enterprise surplus inventory located in currently existing supplies within the enterprise's existing stock for use by such enterprise to exhaust its currently existing stock, and in particular, its surplus inventory. Similarly, the Interplant Relationship file identifies and lists inter-enterprise (i.e., enterprise-to-enterprise) surplus inventory available within existing supplies of such enterprises. This inventory listed in the Interplant Relationship file is capable of being distributed between the various enterprises for exhausting currently existing supplies within these enterprises. Both the Substitute Parts and Interplant Relationship files are maintained at the enterprise levels on networks utilized by such enterprises.

The Substitute Parts file is a listing of surplus inventory within an enterprise identifying a variety of parts that may be used as substitutions, replacements or matching parts within the enterprise. These substitute parts may be up-level parts (e.g., being of higher quality and/or value), equal-level parts (e.g., being of equal quality and/or value), down-level parts (e.g., being of lesser quality and/or value), or even combinations thereof. The substitute part may even be composed of a number of different component substitute parts. In accordance with the invention, each enterprise creates and maintains its own Substitute Parts file.

In the Substitute Parts file, each part listed in the surplus inventory list is identified with an identifier. The identifier may be any designation that uniquely identifies each part listed within the surplus inventory list of the Substitute Parts file. For instance, the identifier may include a part number, a catalog number, catalog name, part name, subpart name, etc. In the preferred embodiment the identifier is a part number. The part number is typically defined during engineering development, and is passed along with the part to the manufacturing systems. Preferably, part numbers are consistent within an enterprise and may be consistent with, or cross-referenced with, other part numbers external to the enterprise. The part number allows the enterprise to identify compatible parts within existing enterprise supplies for substitution and/or allocation with each other, and as such, exhaustion of supplies.

The Substitute Parts file also includes substitution or allocation rules associated with each surplus part in the list of surplus inventory. The substitution/allocation rules are input and maintained by each enterprise for identifying those parts within the enterprise that are compatible with other parts for purposes of allocating and exhausting existing supplies. These rules also indicate those parts listed in the surplus inventory within the Substitute Parts file that are to be used and consumed “as is” (i.e., in its current state) within the enterprise, as well as inventory that is to be “used up” (i.e., inventory that may be modified for purposes of exhausting existing supplies) within the enterprise.

An essential feature is that the surplus inventory listed in the Substitute Parts file is identified before such inventory is ever declared as an overage or excess inventory. This advantageously allows for the exhaustion of existing inventory within the enterprise before it can be identified as overage or excess, which often leads to loss of enterprise time and money due to scraping and/or reworking of excess inventory. The invention also increases the use and consumption of inventory within currently existing supplies, thereby leading to a decrease in the need to acquire or build new parts that may be required, such as due to engineering changes.

The Location and Plant Site Parameters file 10 also includes an Interplant Relationship file. Each enterprise operates and maintains its own Interplant Relationship file for establishing relationships with each other. Each Location and Plant Site Parameters file 10 contains a listing of surplus inventory within the corresponding enterprise, and the enterprise's priorities and preferences for sharing and allocating particular parts within the listed surplus inventory to other enterprises. These listed parts are also identified using an identifier, which is preferably a part number. The parts listed in the surplus inventory list within the Interplant Relationship file may be used as substitutions, replacements or matching parts from enterprise-to-enterprise, and may include up-level, equal-level, or down-level parts, or even combinations thereof. These parts may also be composed of a number of different component substitute parts.

The enterprise also establishes within the Interplant Relationship file substitution/allocation rules that are associated with each part in the list of surplus inventory. These rules define the capabilities of allocating particular parts within surplus inventory to external enterprises, as well as the hierarchy of allocating such parts amongst the various enterprises. In this aspect, these substitution/allocation rules advantageously allow a sending enterprise to exhaust its currently existing supplies, while simultaneously allowing a receiving enterprise to reduce its costs and time in manufacturing and/or eliminate the need to purchase new parts.

The Interplant Relationship file substitution/allocation rules include information on an enterprise's preferences for particular parts, priorities for sending and/or receiving parts, effective dates for designating parts within existing supplies as surplus inventory for allocation in accordance with the invention, minimum and maximum monetary amounts willing to be spent on surplus inventory (e.g., purchasing costs, shipping costs, handling costs, and combinations thereof), and the like. Again, an essential feature is that the surplus inventory listed in the Interplant Relationship input file is to be exchanged between enterprises prior to such inventory ever being declared as an overage or excess inventory, and prior to acquiring or building new inventory within the enterprises.

Another component of the invention is a Central Parameters file 20. The Central Parameters file 20 enables the automatic determination of those parts within surplus inventory that can be substituted or allocated to other enterprises, as well as those parts that are designated as end of life parts. The Central Parameters component includes a Surplus Allocation Parameters file having a Surplus Horizon Days file, a Surplus Duration Days file, and a Use Order Recommendation file. The Central Parameters file also includes an End of Life parts (EOL parts) file and an End of Life suppliers (EOL suppliers) file.

The Surplus Allocation Parameters file is maintained on a network by the corresponding enterprise. Data is input into this file for establishing the actual time horizon and duration for allocating the surplus inventory at an enterprise level, as well as for establishing the hierarchy as to how surplus inventory is to be allocated amongst the various different enterprises. In order to accomplish these tasks, the Surplus Allocation Parameters file includes the Surplus Horizon Days, Surplus Duration Days, and Use Order Recommendation files.

The Surplus Horizon Days file provides the time horizon in which the surplus inventory will be available for allocation and/or sharing. This time horizon is preferably set in days; however, it could be set in any measure of time, such as, minutes, weeks, months, etc. The Surplus Duration Days file provides the time duration that currently existing inventory must reside within an enterprise's stock before it can be declared as surplus inventory for use in accordance with the invention. While this time duration may be set in any measure of time, it is also preferably set in days. The Use Order Recommendation file contains data for determining if open orders exist for a particular part within the surplus inventory, and if so, defines the hierarchy as to how such part is to be allocated amongst the various enterprises desiring such part. The data used to determine the hierarchy allocation includes, but is not limited to, cost considerations and requirements, priorities of certain enterprises with respect to the desired part, and the like.

Referring again to FIG. 1, data stored in the Location and Plant Site Parameters file 10 and the Central Parameters file 20 is input into a Central Planning Engine (CPE) for running the Materials Requirement Planning (MRP) 30 of the invention. Using these critical inputs from the Location and Plant Site Parameters file 10 and the Central Parameters file 20, the MRP 30 run determines the allocation hierarchy of substituting and/or allocating parts within the surplus inventory either intra-enterprise or inter-enterprise prior to such parts and/or surplus inventory being declared as an overage or excess.

At the beginning of an MRP 30 run (or rerun), the Substitute Parts file, Interplant Relationship file, and Surplus Allocation Parameters file are all exported from the enterprise networks as raw data files, and input into the CPE for the MRP 30 run. In so doing, the MRP 30 utilizes the intra-enterprise substitute part data from the Substitute Parts file, the inter-enterprise substitute part data from the Interplant Relationship file, and the surplus horizon, surplus duration, and allocation hierarchy data from the Surplus Allocation Parameters file to determine the availability of parts within surplus inventory, and the allocation of such parts across both intra- and inter-enterprise sites.

In accordance with the invention, the MRP 30 receives an input of an identification of a part from an enterprise, whereby the identification is preferably a part number. This part may be either a desired part that the enterprise needs or is seeking to purchase, or it may be a part within the enterprise's existing surplus inventory that the enterprise is seeking to exhaust. The MRP 30 compares the part number to the listed surplus inventories listed to determine if a compatible part resides within currently existing inventories either in the input Substitute Parts file for intra-enterprise allocation, or in the Interplant Relationship file for inter-enterprise allocation. It should be understood that the compatible part may be an identical part to the part entered into the system, an equivalent part (i.e., the designated “use up/as is” part), or a substitute part that has the capabilities and requirements of the entered part.

If the MRP 30 locates a compatible part within the surplus inventory listed in the Substitute Parts input file, the system sends a notification that the part number entered into the MRP 30 exists within the enterprise's currently existing inventory. The MRP 30 then defines the hierarchy of allocation as preferably first disbursing the compatible part located in the Substitute Parts input file internally within the enterprise (i.e., intra-enterprise) for exhausting the enterprise's currently existing inventory. This defined hierarchy allocation is sent from the MRP as an output file, which is discussed further below, for viewing and selection by the user of the invention. In so doing, the MRP 30 utilizes the rules within the Substitute Parts file to allow the exhaustion of “as is” parts or “used up” parts intra-enterprise.

For example, where enterprise “A” has a need for 100 units of part “A”, an identification of part “A” is input into the present system. The MRP 30 analyzes the input part “A” identification and determines through the Substitute Parts input file that enterprise “A” actually has 100 units of part “A” available within currently existing stock. The MRP 30 generate s an output table 50 to enterprise “A” notifying enterprise “A” of its available in-house stock of 100 units of part “A” for intra-enterprise allocation and exhaustion of existing inventory. Enterprise “A” may select and use its own internally available supplies for exhaustion, or alternatively, it may select another hierarchy allocation plan from the output table depending upon the wants and needs of the enterprise.

In the event the MRP 30 is unable to locate a compatible part within the Substitute Parts input file, the MRP 30 then analyzes the input Interplant Relationship file for the listing of a compatible part. If a compatible part is located within the Interplant Relationship file, the MRP 30 then utilizes the substitution/allocation rules within this file, and combines such rules with those rules from the Central Parameters file. This enables the MRP 30 to determine the sharing capabilities and allocation hierarchy of the various parts within the lists of surplus inventory amongst the different enterprises.

If the compatible part is located in the Interplant Relationship file, the substitution/allocation rules in the Surplus Allocation Parameters file are retrieved from the Central Parameters file 20. In so doing, the Surplus Duration Days file sets the time duration that inventory must reside within an enterprise's stock before it can be declared as surplus, while the Surplus Horizon Days file sets the time horizon within which surplus inventory will be available for allocation and distribution as a compatible part amongst the enterprises. The MRP 30 then utilizes this data to determine both a date on which compatible parts within surplus inventory will be available as well as a quantity of such parts that will be available on such date.

Once the MRP 30 determines that an enterprise has a given quantity of a surplus part available on a given date, the MRP 30 utilizes the enterprise inputs from the Interplant Relationship file to define a hierarchy as to how each available surplus part is to be allocated amongst the enterprises. This hierarchy is defined by establishing the preferences and priorities of distribution and allocation of the available surplus parts amongst the various enterprises. The MRP 30 analyzes each enterprise's preferences for particular parts, priorities for sending and/or receiving parts, and the enterprise's minimum and maximum monetary amounts willing to be spent on such parts, and utilizes this data to define the allocation hierarchy. The MRP 30 may also utilize an enterprise's supply hierarchy rules to determine the priorities and preferences for sending supplies from the enterprise. For instance, an enterprise's supply hierarchy may be in the sequential order of first sending supply (e.g., on-hand inventory, forecasted returns, Firm Purchase Orders, substitute supply/shared supply), which is utilized prior to a new build or a new purchase.

For example, where enterprise “A” has a need for 100 units of part “A”, the identification of part “A” is input into the system. The MRP 30 analyzes the Substitute Parts input file to find that enterprise “A” has 30 units of parts compatible with part “A” available internally. These 30 units of compatible parts may be the exact part (i.e., part “A”), parts compatible with part “A”, or parts equivalent to part “A”. The MRP 30 continues to analyze its inputs from the Interplant Relationship file (i.e., inter-enterprise) to search for more parts compatible with part “A” that may exist in other enterprises external to enterprise “A”. In this example, the MRP 30 locates 50 units of compatible parts in enterprise “B”, and 100 units of compatible parts in enterprise “C”. Using the allocation rules from the Substitute Parts file, the Interplant Relationship file and the Central Parameters file, the MRP 30 determines all the available hierarchy allocation plans that will allow enterprise “A” to fulfill its need for 100 units of part “A”. For instance, depending upon the various preferences and priorities set by enterprises A, B and C, enterprise “A” may fulfill its need for 100 units of part “A” by selecting all 100 units from enterprise “C”, or 30 units from enterprise “A” plus 70 units from enterprise “C”, or 30 units from enterprise “A” plus 50 units from enterprise “B” plus 20 units from enterprise “C”, or the various other combinations that are available and output from the MRP in the output table.

Also used to define the allocation hierarchy is the Use Order Recommendation file from the Central Parameters. This file is used to determine if open orders exist for a particular part within the surplus inventory, and if so, defines the hierarchy as to how such part is to be allocated amongst the various enterprises. The MRP 30 uses the Use Order Recommendation file to create recommendations for filling open orders, which may be filled before or after allocation in accordance with the invention. It should be appreciated that since the MRP 30 is continually running, the quantities of located available compatible parts may be based upon requests as they are input into the present system, or they may be based on quantities of available compatible parts after any open orders have been fulfilled.

In addition, the Central Parameters file 20 further includes an EOL parts file and an EOL supplier file, which are both input into the MRP 30. The EOL parts file identifies those parts and associated plans that are using such parts within an enterprises' surplus inventory that have been designated as no longer having a useful life (i.e., end of life or “EOL”), such as, due to discontinuation or engineering changes. The EOL suppliers file identifies enterprises that are willing to share or allocate EOL parts. In so doing, the EOL suppliers file establishes relationships between enterprises willing to share EOL parts.

Once a part number has been entered into the present system, the MRP 30 may additionally determine if the part is listed as an EOL part within the listed surplus inventories in either the Substitute Parts file or the Interplant Relationship file. If the part is an EOL part, then the MRP 30 uses the substitution/allocation rules from the Substitute Parts file, the Interplant Relationship file and/or the Central Parameters file, in combination with the rules from the EOL suppliers file to identify those enterprises (i.e., suppliers) having EOL parts, and provides a listing of such enterprises that are willing to allocate and share EOL parts with other enterprises. This information is used to define and build the hierarchy allocation plans that the user may select from in order to fulfill the user's request input into the system.

Thus, in accordance with the invention, once a desired part number is entered into the present system, the MRP 30 analyzes the input Substitute Parts and Interplant Relationship files to determine those parts within currently existing inventories that can be used up for purposes of exhausting existing supplies both intra-enterprise and inter-enterprise. The MRP 30 also determines whether the desired part number is an EOL part, and if so, provides a list of EOL suppliers that the EOL part can be shared with. The MRP 30 establishes the hierarchy of allocation of parts listed in surplus inventories using the input rules from the Substitute Parts, Interplant Relationship and/or Central Parameters files.

If the MRP locates an identical part or a compatible part internally, then the MRP 30 will utilize the allocation rules from the Substitute Parts file to build the hierarchy of allocation which is output in the output table (e.g., in the Substitute Supply output file). However, if an identical part is located externally (inter-enterprise), then the MRP 30 utilizes the allocation rules from the Interplant Relationship file and the Central Parameters file 20 for determining the hierarchy allocation. Still further, if the MRP 30 locates a non-identical compatible part externally, then the MRP 30 uses the rules from the Substitute Parts file, the Interplant Relationship file and the Central Parameters file 20 to determine those parts that the requesting enterprise has established as being compatible with the requested part, as well as the hierarchy allocation for these compatible parts.

The MRP 30 generates output tables 50 for displaying the hierarchy allocation plans for selection by the user. These hierarchy allocation plans allocate the available surplus inventory in a timely and orderly fashion according to the various input substitution/allocation rules. The output tables 50 include a Substitute Parts output file, an Interplant Relationship output file, and a Substitute Supply file. The Substitute Parts output file contains a listing of parts compatible with the requested input part within the surplus inventory lists that were located during the MRP 30 run, while the Interplant Relationship output file contains a listing of enterprises that are willing to share or allocate supplies (to either the requesting entity or any entity) located during the run. The essential output of the MRP 30 is the Substitute Supply output file. This output file contains and displays the hierarchy allocation plans for selection by the user, whereby each plan shows a listing of those enterprises willing to share or allocate located compatible parts and the amounts of such compatible parts that the enterprises has in its existing supplies or is willing to share with other entities.

The MRP 30 also generates and outputs Reports 40 for providing future demand forecasts based on the results of the current MRP 30 run, or even based on a plurality of MRP 30 runs and/or reruns. The Reports 40 include planning sheets for future and current requested parts, status of requested parts (e.g., when parts can be shipped, the delivery records, when parts will be available for shipping, etc.), gross summing of parts, requested parts within currently available supplies, the demands for such parts, and combinations thereof. Thus, in accordance with the invention the output Reports 40 advantageously include visibility to the surplus inventories allocation.

For example, the MRP output tables 50 may show the parts allocations as a matched pair of substitute part supplies to demand requests. The sending enterprise stocking the surplus parts for allocation will view demands for both a requested quantity and a requested date needed by that are input by the receiving enterprise making the demand. The receiving enterprise will then view the substitute supply outputs for an available quantity and date currently available within existing supplies in an enterprise. These demand/supply outputs indicate the material movements that the present MRP system assumes will be implemented, such as with open order recommendations.

The present process of running the MRP 30 preferably continues until substantially all currently available surplus supplies have been exhausted. As long as excess surplus inventories reside within the enterprises, the MRP 30 will attempt to allocate and disburse such supplies until all supplies and rules have been exhausted. Another essential feature is that the hierarchy of allocation is calculated during the MRP 30 run such that the MRP 30 is able to output a table listing the allocation plans for parts within listed surplus inventories. The MRP does not generate an output identifying excess inventory since the entire run is performed and completed before any inventory can be declared as excess.

The invention advantageously allows enterprises to assign and/or share substitute parts in a timely manner, for exhausting currently existing supplies and avoiding the need to make or purchase new inventories. In so doing, the invention saves manufacturing costs and time by supporting inventory usage of currently existing surplus and scrap parts for substantially eliminating inventory liability for parts otherwise planned as prime. It also eliminates validation errors and exhaustive analysis time by enabling engineering changes to be implemented automatically at all levels versus manually trying to predict such changes. The invention accomplishes these tasks by using up existing “as is” parts, and/or exhausting “use up” parts, before such parts are discontinued and/or declared as excess inventory.

It should be appreciated that components of the present invention may be embodied as a computer program product stored on a program storage device. These program storage devices may be devised, made and used as a component of a machine that utilizes optics, magnetic properties and/or electronics to perform certain of the method steps of the present invention. Such program storage devices may include, but are not limited to, magnetic media such as diskettes or computer hard drives, magnetic tapes, optical disks, Read Only Memory (ROM), floppy disks, semiconductor chips and the like. A computer readable program code means in known source code may be employed to convert certain of the method steps described below. This computer readable program code contains instructions embodied in tangible media, such as floppy disks, CD-ROMS, hard drives, or any other computer-readable storage medium, wherein, when the computer program code is loaded into and executed by a computer, the computer becomes an apparatus for practicing the invention.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method for exhausting surplus inventory comprising:
identifying existing surplus inventory;
inputting lists of said surplus inventory into a planning engine;
inputting allocation rules into said planning engine;
inputting an identifier of a requested part into said planning engine;
analyzing said lists of surplus inventory in said planning engine to locate compatible parts using said identifier of said requested part
generating hierarchy allocation plans based on said allocation rules and said compatible parts; and
outputting said hierarchy allocation plans from said planning engine for allowing a user to select at least one of said hierarchy allocation plans for exhausting said existing surplus inventory.

2. The method of claim 1 wherein said step of inputting said lists of said surplus inventory comprises:
inputting an intra-enterprise list of available surplus inventory within an enterprise whereby intra-enterprise allocation rules are associated with said intra-enterprise lists;
inputting inter-enterprise lists of available surplus inventory from various enterprises whereby inter-enterprise allocation rules are associated with said inter-enterprise lists, said inter-enterprise lists establishing relationships between said various enterprises by identifying selected ones of said various enterprises that are willing to allocate compatible parts to other said various enterprises; and
inputting a central parameters file for automatically identifying those parts within said inter-enterprise lists of surplus inventory that can be allocated to said other enterprises.

3. The method of claim 2 wherein said step of locating said compatible parts within said lists of surplus inventory further comprises:
analyzing said intra-enterprise list of available surplus inventory for said compatible parts;
locating said compatible parts within said intra-enterprise list; and
generating said hierarchy allocation plans using said intra-enterprise allocation rules and said compatible parts located within said enterprise for exhausting existing surplus inventory within said enterprise.

4. The method of claim 2 wherein said step of locating said compatible parts within said lists of surplus inventory further comprises:
analyzing said inter-enterprise lists of available surplus inventory for said compatible parts;
locating said compatible parts within said inter-enterprise lists;
determining if said located compatible parts comprise identical compatible parts to said requested part; and
if said compatible parts comprise identical compatible parts, generating said hierarchy allocation plans using said inter-enterprise lists of available surplus inventory, said central parameters file, and said identical compatible parts for exhausting existing surplus inventory with said various enterprises.

5. The method of claim 2 wherein said step of locating said compatible parts within said lists of surplus inventory further comprises:
analyzing said inter-enterprise lists of available surplus inventory for said compatible parts;
locating said compatible parts within said inter-enterprise lists;
determining if said located compatible parts comprise identical compatible parts to said requested part; and
if it is determined that said compatible parts are non-identical compatible parts, generating said hierarchy allocation plans using said intra-enterprise list of available surplus inventory, said inter-enterprise lists of available surplus inventory, said central parameters file, and said non-identical compatible parts for exhausting existing surplus inventory with said various enterprises.

6. The method of claim 2 wherein said inter-enterprise allocation rules include information selected from the group consisting of enterprise preferences for said compatible parts, enterprise priorities for sending said compatible parts, enterprise priorities for receiving said compatible parts, expenditure allowances, and combinations thereof.

7. The method of claim 6 wherein said central parameters file includes substitution rules for determining a time line for declaring stocked inventory as said surplus inventory, a time horizon of availability of said surplus inventory, and a quantity of available said surplus inventory.

8. The method of claim 2 further including determining if open orders exist for said compatible parts within said inter-enterprise lists of surplus inventory using said central parameters file, and if said open orders exist, generating said hierarchy allocation plans using said open orders.

9. The method of claim 2 wherein using said central parameters file said method further comprises:
determining if said compatible parts comprise end-of-life parts;
if said compatible parts comprise end-of-life parts, identifying end-of-life enterprises willing to allocate and share said end-of-life parts; and
generating said hierarchy allocation plans using said end-of-life parts.

10. The method of claim 1 wherein each of said compatible parts is selected from the group consisting of an identical part, an equivalent part, a non-identical substitute part, an up-level part, an equal-level part, a down-level part, and combinations thereof.

11. The method of claim 1 wherein said hierarchy allocation plans are output to said user prior to said lists of surplus inventory being declared as excess inventory.

12. The method of claim 1 wherein said planning engine includes a Materials Requirement Planning component for generating said hierarchy allocation plans.

13. The method of claim 1 wherein said user comprises an enterprise selected from the group consisting of a plant, a factory, a manufacturer, a supplier, a distributor and a storage facility.

14. The method of claim 1 wherein said identifier is selected from the group consisting of a part number, a catalog number, a catalog name, a part name and a subpart name.

15. The method of claim 1 wherein said planning engine outputs said hierarchy allocation plans in output tables, whereby each hierarchy allocation plan identifies enterprises willing to allocate said compatible parts to other enterprises for exhausting said existing surplus inventory.

16. The method of claim 1 further including said planning engine outputting reports for providing future demand forecasts of said existing surplus inventory based on said output hierarchy allocation plans.

17. A system for exhausting surplus inventory comprising:
a location and plant site parameter file for inputting lists of surplus inventory, whereby allocation rules are associated with each part within said lists;
a central parameter file for inputting data on selected said parts within said lists of surplus inventory that can be allocated amongst various enterprises;
a planning engine for receiving an identification of a requested part and said inputs from said location and plant site parameter file and said central parameter file;
a Materials Requirement Planning component of said planning engine for analyzing said inputs for compatible parts with said requested part, and for generating hierarchy allocation plans based on said allocation rules and said compatible parts prior to said lists of surplus inventory being declared as excess inventory.

18. The system of claim 16 wherein said location and plant site parameter file includes a Substitute Parts file for inputting an intra-enterprise list of available surplus inventory from a single enterprise and an Interplant Relationship file for inputting inter-enterprise lists of available surplus inventory from various enterprises for generating said hierarchy allocation plans.

19. The system of claim 16 further including said Materials Requirement Planning component generating and outputting:
output tables for displaying said hierarchy allocation plans; and
output reports for providing future demand forecasts of said surplus inventory based on said output hierarchy allocation plans.

20. A program storage device readable by a processor capable of executing instructions, tangibly embodying a program of instructions executable by the processor to perform method steps for exhausting surplus inventory, said method steps comprising:
identifying existing surplus inventory;
inputting lists of said surplus inventory into a planning engine;
inputting allocation rules into said planning engine;
inputting an identifier of a requested part into said planning engine;
analyzing said lists of surplus inventory in said planning engine to locate compatible parts using said identifier of said requested part
generating hierarchy allocation plans based on said allocation rules and said compatible parts; and
outputting said hierarchy allocation plans from said planning engine for allowing a user to select at least one of said hierarchy allocation plans for exhausting said existing surplus inventory.
